(19) United States
(12) Patent Application Publication
(10) Pub. No.: US 2016/0141921 A1
(43) Pub. Date: May 19, 2016

(54) HELICAL HEAT EXCHANGER FOR ELECTRIC MOTORS

(71) Applicant: Arnold Magnetic Technologies, Rochester, NY (US)

(72) Inventor: Larry A. Kubes, Indianapolis, IN (US)

(21) Appl. No.: 14/542,970

(22) Filed: Nov. 17, 2014

(51) Int. Cl. H02K 1/20; B23K 20/10; H02K 15/02; B23K 31/02

(52) U.S. Cl. CPC H02K 1/20; B23K 31/02; B23K 20/10; H02K 15/02

(57) ABSTRACT

An electric motor has a stator, a rotor, and a helical heat exchanger disposed outboard of the stator. The helical heat exchanger includes: an inner sleeve; an outer sleeve coaxially disposed with and outboard of the inner sleeve with a void therebetween; at least one helical wall disposed in the void between the inner and outer sleeves extending from one end to an opposite end of the inner and outer sleeves; the at least one helical wall forming a fluid tight seal along its helical path to define at least one helical fluid flow path in the void between the inner and outer sleeves; and the at least one helical fluid flow path configured to permit at least one heat transfer medium to helically travel within the void between the inner and outer sleeves.

### BACKGROUND OF THE INVENTION

The present disclosure relates generally to electric motors, more particularly to heat exchangers for electric motors, and even more particularly to a helical heat exchanger for electric motors.

As electric motors, and other mechanical devices, are driven to their limits in a, variety of applications, it is becoming more cost competitive to use a smaller device and drive it harder and/or faster. Increasing the torque and speed output of such a device results in the production of more power output, as well as heat.

Heat removal is an important factor to driving these devices harder and faster. This is especially evident as devices become smaller, in that these devices now have decreased surface area as well as reduced thermal mass and thermal inertia, which causes higher heat production and retention.

Electric vehicle and system designers are faced not only with cost pressures, but also with downsizing the machinery that they are engineering. Devices and motors that offer a smaller package size are very desirable in achieving the smallest system size, while still maintaining performance goals. As a result, space optimization, paired with high performance, offers engineers very desirable components to meet these needs.

In an electric motor, the stator, or fixed portion, is typically on the outside of the motor electromagnetic assembly and produces most of the heat within the motor due to rapid changes in the flow of electrons within the windings of the stator. The windings of the stator are electrical conductors, typically made from many strands of copper wire, that are wound onto the poles of stamped electrical grade steel laminations that help to focus the electrons energy into magnetic energy. This magnetic energy attracts and repels the poles of the rotational, inner part of the motor, the rotor. The rotation of the rotor, which is rigidly coupled to the output shaft of a motor, produces torque.

Laminated steel is typically used in the construction of the stator in motors, and in the construction of the rotor for many motors. The reasoning for using laminated steel in these areas is to reduce Eddy currents that are formed during the changes in the flow of electrons, which cause an increase in heating of the motor and reduced performance. Eddy currents would be at a maximum if a solid form instead of a laminated form was used to form the rotor or stator. By using very thin laminations, only small Eddy currents are formed, which lead to minimal power reductions and heat production. It is these Eddy currents, and natural copper resistance losses, along with other minimal contributors, that cause a motor to heat.

Running electric motors cooler can increase their performance. Removing heat from the electric motor causes a reduction in the copper resistance, which reduces loses, as well as improved performance of the magnetic materials when used in electric motors that employ some sort of magnetic material in the rotor, such as permanent magnet motors. In short, if a structurally smaller electric motor can deliver the same performance as a relatively larger electric motor of comparative torque output, the smaller electric motor will be favored due to is reduced cost due to less quantity of materials and easier packaging into a system due to its smaller size.

A basic form of cooling used in electric motor is air cooling. However, air has much less heat transfer capability than some liquids, such as water or oil. In some cases, the heat transfer capability of air is over 1000× less than a readily available liquid. Many old electric motors and large frame industrial electric motors use air as a cooling medium, due to its low cost and simple design. In all cases, air cooled electric motors are much larger than their liquid cooled counterparts, due to the fact that air cooled electric motors have to have large air passageways to flow enough air to get the desired cooling effect, and thermal inertia of a large massive housing is used to conduct heat away from the electric motor and into the surroundings.

As electric motor performance increases, liquid cooling is more preferred. This is due to the fact that air flow cannot efficiently transfer enough heat out of the electric motor, resulting in electric motor sizes being constrained. For example, a 10 HP air cooled electric motor has a volume typically around 4-5 Liters, whereas a 100 HP liquid cooled electric motor can be 50% of this volume, or smaller. Some liquid cooled electric motors utilize a jacket around the stator of the electric motor, with a cooling medium flowing through the jacket, typically water and ethylene glycol (anti-freeze) mixture, called WEG. Basic designs of a cooling channel formed by the jacket typically involve a simple “in” flow port at the bottom of the electric motor, a flow path around the jacket that encompasses the stator, and “out” flow port at the top of the electric motor. This type of water cooling jacket is low cost and easy to produce, however, overall effectiveness is satisfactory at best. Often liquid flow becomes laminar and does not effectively “scrub” heat off of the hot surface of the floor of the waterjacket, which may impact the compactness of the electric motor design.

As cooling system designs for electric motors have evolved, other methods have been employed to disturb laminar flow of the WEG and provide a scrubbing effect to remove heat from the floor of the waterjacket. These other methods also increase the amount of time that the WEG is in contact with the “hot” waterjacket floor, which results in increased coolant effectiveness. Methods that result in increased coolant effectiveness typically involve utilization of a tortuous or zig-zag shaped fluid flow path through the coolant jacket. This zig-zag path typically employs some type of bars or ribs that run along the axis of the motor in an overlapping pattern. This overlapping pattern causes the coolant to first flow in one direction, and then after arriving at the end of the bar/rib the flow turns and runs towards the next bar/rib, and then ultimately turns and runs in reverse direction along the next bar/rib, until it reaches another opening, and the process repeats itself. The tortuous path created by such bars/ribs is typically cast into the housing, but in some electric motors features such as rods can be inserted into a normal cooling path to give the jacket this zig-zag effect. Benefits of this type of cooling system includes improved cooling and cooling effectiveness. However, such cooling systems are typically hard to cast, and in the cast of the installed rod method are typically hard to machine and employ.

While existing heat exchangers for an electric motor may be suitable for their intended purpose, the art relating to heat exchangers for an electric motor would be advanced with a helical heat exchanger as disclosed herein.

This background information is provided to reveal information believed by the applicant to be of possible relevance to the invention. No admission is necessarily intended, nor should be construed, that any of the preceding information constitutes prior art against the invention.

### BRIEF DESCRIPTION OF THE INVENTION

An embodiment of the invention includes an electric motor having a stator, a rotor disposed axially, magnetically, and operably with respect to the stator, and a helical heat exchanger disposed outboard of the stator and in thermal communication with at least the stator. The helical heat exchanger includes: an inner sleeve having a first inner surface and a first outer surface separated by a first thickness; an outer sleeve having a second inner surface and a second outer surface separated by a second thickness, the outer sleeve coaxially disposed with and outboard of the inner sleeve with a void therebetween; at least one helical wall disposed in the void between the inner and outer sleeves extending from one end to an opposite end of the inner and outer sleeves; the at least one helical wall forming a fluid tight seal along its helical path between the first outer surface and the second inner surface to define at least one helical fluid flow path in the void between the inner and outer sleeves; and the at least one helical fluid flow path configured to permit at least one heat transfer medium to helically travel within the void between the inner and outer sleeves.

An embodiment of the invention includes a method of fabricating a helical heat exchanger for use with an electric motor. An inner sleeve is formed having a first inner surface and a first outer surface separated by a first thickness. At least one helical wall is provided and disposed on the first outer surface of the inner sleeve extending from one end to an opposite end of the inner sleeve, An outer sleeve is formed having a second inner surface and a second outer surface separated by a second thickness. The outer sleeve is disposed coaxially with and outboard of the inner sleeve with a void between the first outer surface and the second inner surface, with the at least one helical wall disposed between the first outer surface and the second inner surface, and with the at least one helical wall disposed in a fluid-tight arrangement between the first outer surface and the second inner surface. The at least one helical wall defines at least one helical fluid flow path configured to permit at least one heat transfer medium to helically travel within the void between the inner and outer sleeves.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures:

FIG. 1 depicts a disassembled assembly view of an electric motor in accordance with an embodiment of the invention;

FIG. 2 depicts a disassembled assembly view of a helical heat exchanger having an inner sleeve and an outer sleeve for use with the electric motor of FIG. 1 in accordance with an embodiment of the invention;

FIG. 3 depicts a portion of the inner sleeve of the helical heat exchanger of FIG. 2 in accordance with an embodiment of the invention;

FIG. 4 depicts a portion of the inner sleeve of the helical heat exchanger of FIG. 2 in accordance with an embodiment of the invention;

FIG. 5 depicts in cross section view an outer sleeve portion of the helical heat exchanger of FIG. 2 in accordance with an embodiment of the invention;

FIG. 6 depicts an alternative inner sleeve portion of the helical heat exchanger of FIG. 2 in accordance with an embodiment of the invention;

FIG. 7 depicts another alternative inner sleeve portion of the helical heat exchanger of FIG. 2 in accordance with an embodiment of the invention;

FIG. 8 depicts in cross section view another outer sleeve portion of the helical heat exchanger of FIG. 2 in accordance with an embodiment of the invention; and

FIG. 9 depicts a schematic of the electric motor of FIG. 1 in combination with: a sump; and, a pump and secondary heat exchanger, in accordance with an embodiment of the invention.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

An embodiment of the invention, as shown and described by the various figures and accompanying text, provides a helical heat exchanger for an electric motor, where the heat exchanger is disposed in intimate thermal communication with an outer surface of a stator of the motor. In an embodiment, the intimate thermal communication is provided by heat shrink fitting the heat exchanger onto the stator or an outer surface of the electric motor housing. The helical heat exchanger comprises coaxially arranged inner and outer cylindrical sleeves with a void therebetween, and at least one helical wall disposed within the void from one end to an opposite end of the sleeves. The at least one helical wall may be one, two, or more helical walls, and may be formed in a variety of ways, which are described below in detail with reference to the drawings provided herein.

While embodiments described and illustrated herein depict a helical heat exchanger for use with electric motors, it will be appreciated that the disclosed invention may also be useful for devices other than electric motors. For example, many different types of equipment, such as hydraulic pumps and motors, and air conditioning compressors, for example, can use an embodiment of the helical heat exchanger as described herein below, but as an exemplary device the description herein will focus on the use of the helical heat exchanger on electric motors and generators. As such, the invention disclosed herein is not limited for use with just electric motors, but encompasses all uses within the scope of the invention disclosed herein.

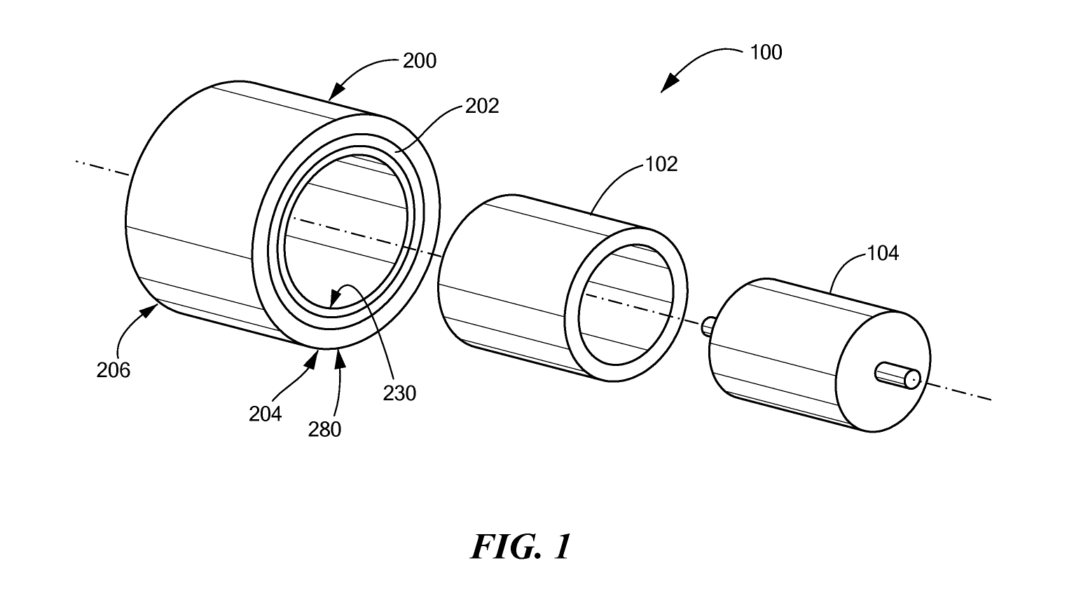

FIG. 1 depicts a disassembled assembly view of an electric motor 100 in accordance with an embodiment of the invention. The electric motor 100 includes a stator 102, a rotor 104, and a helical heat exchanger (HHE) 200. The rotor 104 is disposed axially, magnetically, and operably with respect to the stator 102 in a manner known in the art. The HHE 200 is disposed outboard of the stator 102 and in thermal communication with at least the stator 102. In an embodiment, the HHE 200 is disposed in direct thermal contact with an outer surface of the stator 102, and may be heat shrink fit to the stator 102 to provide intimate direct thermal contact therewith. As depicted, an embodiment of the electric motor 100 is configured such that each of the stator 102, the rotor 104, and the HHE 200 is cylindrical in structure.

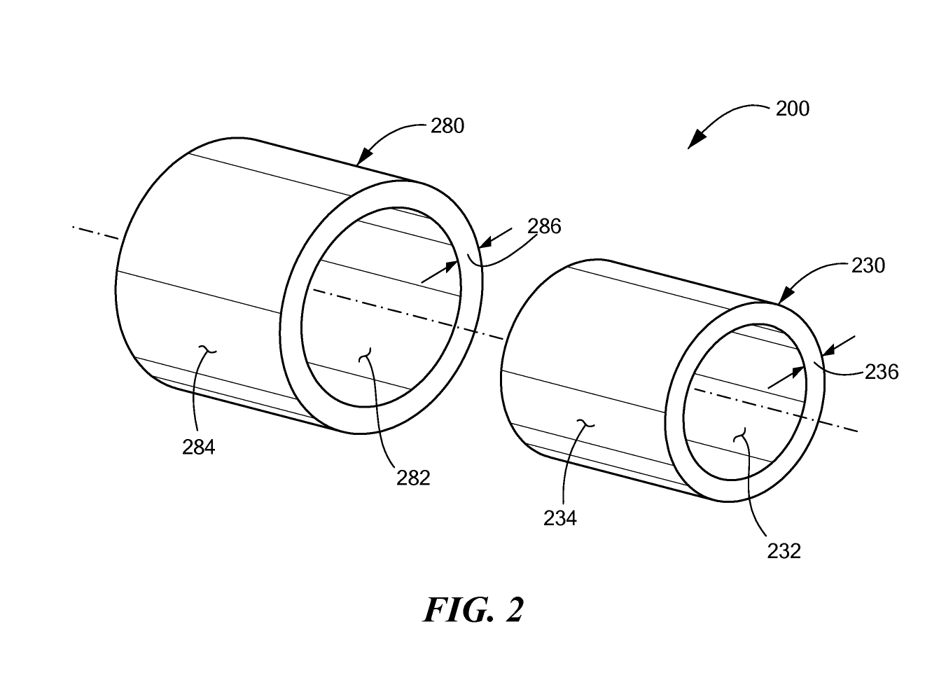

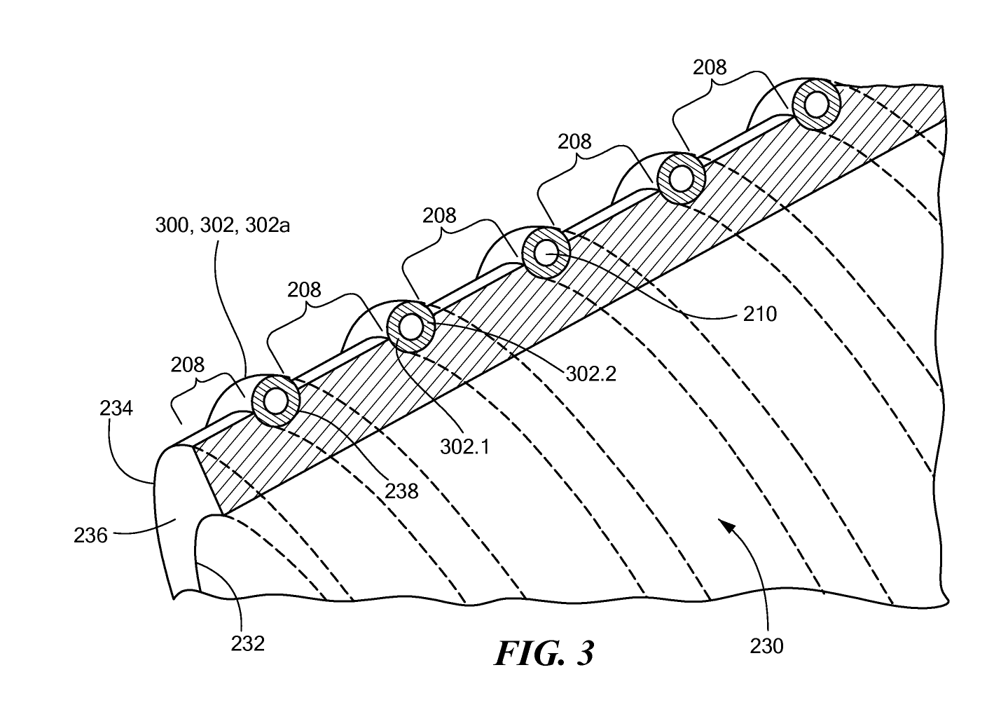

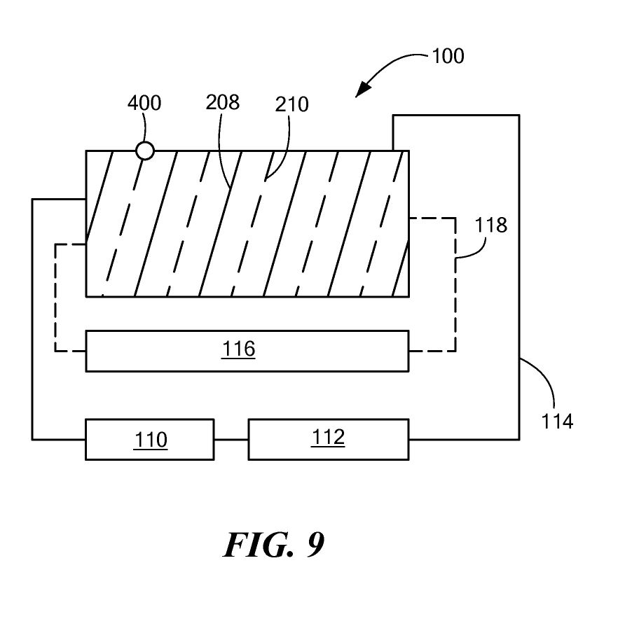

With reference to FIGS. 1 and 2, the HHE 200 includes an inner sleeve 230 and an outer sleeve 280, with the outer sleeve 280 being coaxially disposed with and outboard of the inner sleeve 230 with a void 202 therebetween. The inner sleeve 230 has a first inner surface 232 and a first outer surface 234 separated by a first thickness 236. The outer sleeve 280 has a second inner surface 282 and a second outer surface 284 separated by a second thickness 286. At least one helical wall (herein referred to generally by reference numeral 300, and best seen with reference to FIG. 3) is disposed in the void 202 between the inner and outer sleeves 230, 280 extending from one end 204 to an opposite end 206 of the inner and outer sleeves 230, 280. The at least one helical wall 300 forms a fluid-tight seal along its helical path between the first outer surface 234 and the second inner surface 282 to define at least one helical fluid flow path 208 (best seen with reference to FIGS. 3, 4, 6, 7 and 9) in the void 202 between the inner and outer sleeves 230, 280. The at least one helical fluid flow path 208 is configured to permit at least one heat transfer medium (114, 118, best seen with reference to FIG. 9) to helically travel within the void 202 between the inner and outer sleeves 230, 280. In an embodiment, the at least one helical wall 300 extends in a continuous and uninterrupted arrangement from the one end 204 to the opposite end 206 of the inner and outer sleeves 230, 280.

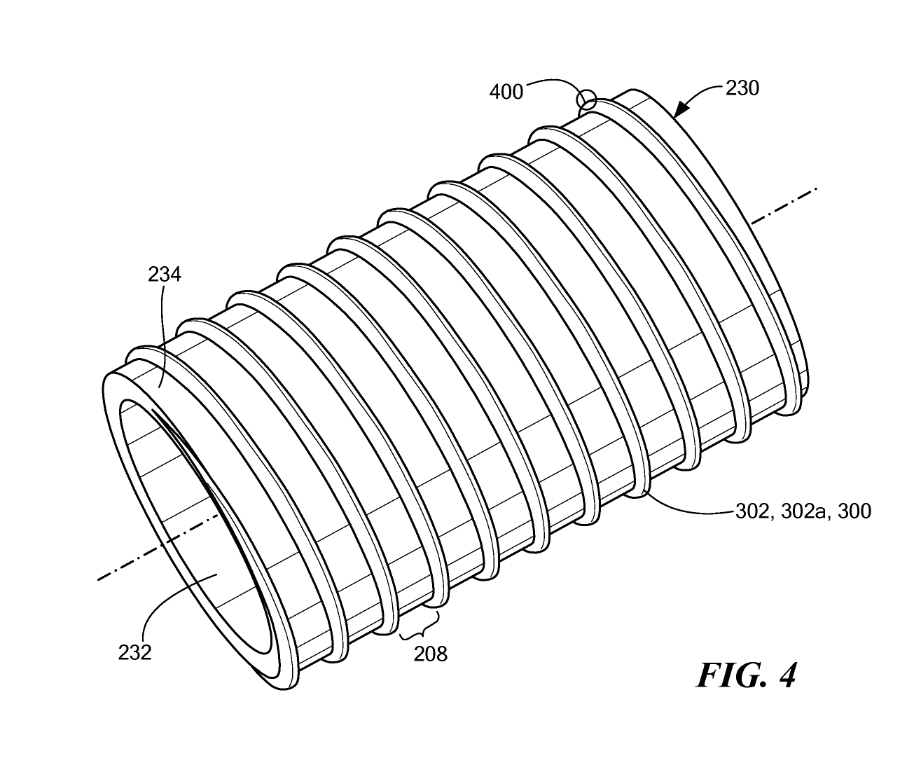

With reference now to FIGS. 3 and 4, an embodiment includes an arrangement where the at least one helical wall 300 is provided by a helix member 302, which may be a hollow helix member 302 as depicted (such as a metal tube, or other suitable material, for example), or a solid helix member 302a (similar to or the same as 302 but solid, such as a metal wire, or other suitable material, for example). To facilitate placement of the helix member 302, 302a on the outside of the inner sleeve 230, the outer surface 234 of the inner sleeve 230 may have a helical groove 238 formed partially into the thickness 236 of the inner sleeve 230, with the helix member 302, 302a being helically disposed therein. The helical groove 238 may be machined into the outer surface 234, or integrally formed with the outer surface 234 during a fabrication process, such as a twisted extrusion metal casting process, or die casting, for example, or powdered metal casting.

In a first embodiment where the helix member is a solid helix member 302a (illustrated in FIG. 3 as being hollow, but understood to be solid when herein referred to as “a solid helix member 302a”), the solid helix member 302a itself forms a single helical wall between the inner and outer sleeves 230, 280, which in turn forms a single helical fluid flow path 208 between the inner and outer sleeves 230, 280 that extends from the one end 204 to the opposite end 206 of the inner and outer sleeves 230, 280.

In a second embodiment where the helix member is a hollow helix member 302 (as illustrated in FIG. 3), the hollow helix member 302 itself, by virtue of the tubular wall construction, forms two helical walls 302.1, 302.2 between the inner and outer sleeves 230, 280, which in turn forms two helical fluid flow paths 208, 210 between the inner and outer sleeves 230, 280 that extends from the one end 204 to the opposite end 206 of the inner and outer sleeves 230, 280, where the first helical fluid flow path 208 is the same as that described above in connection with the first embodiment, and the second helical fluid flow path 210 is the central tubular opening within the hollow helix member 302.

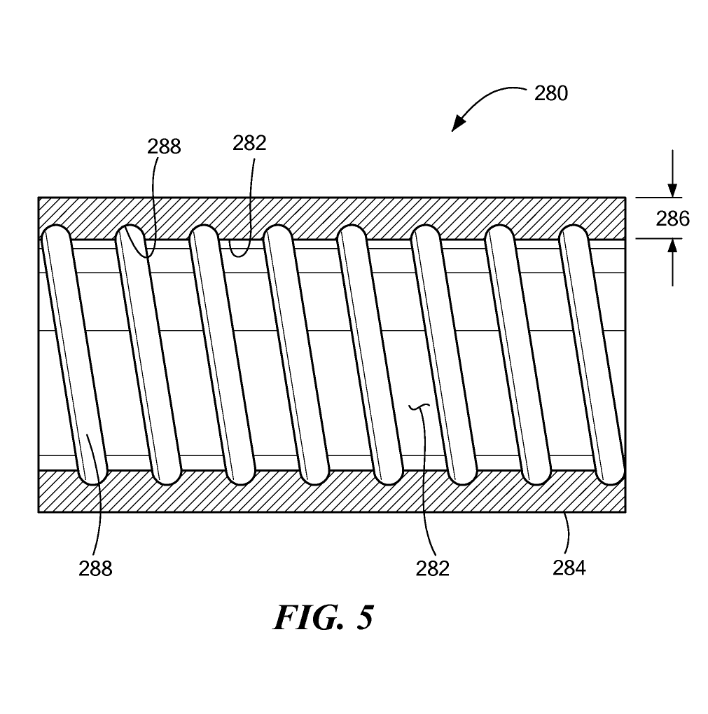

Reference is now made to FIG. 5. In a third embodiment, which may be combinable with either or both of the aforementioned first and second embodiments, the second inner surface 282 of the outer sleeve 280 has a helical groove 288 formed partially in the second thickness 286, which provides a track for the helix member 302, 302a to be disposed therein.

By providing helical grooves 238, 288 on the inner and outer sleeves 230, 280, respectively, the (HHE) 200 may be fabricated by first winding the helix member 302, 302a (one or the other, depending on whether the HHE 200 is to have one or two fluid flow paths 208, 210) in the helical groove 238 on the inner sleeve 230 to form a screw-type inner sleeve structure, and then threading the outer sleeve 280 onto the inner sleeve 230, or vice versa, by engaging the helix member 302, 302a with the helical groove 288 on the outer sleeve 280, resulting in the inner and outer sleeves 230, 280 being assembled in a screw-type relationship via the helix member 302, 302a and the helical grooves 238, 288.

The helical groove 288 may be machined into the second inner surface 282 of the outer sleeve 280, or may be integrally formed with the outer sleeve 280 via a twisted extrusion process or extruded casting process, or may be subsequently formed via a machining process.

Alternatively, the outer sleeve 280 may be fabricated as two “half-pipes” with the helical groove 288 formed into each half-pipe, and the two half-pipes secured together over the inner sleeve 230 and helix member 302, 302a.

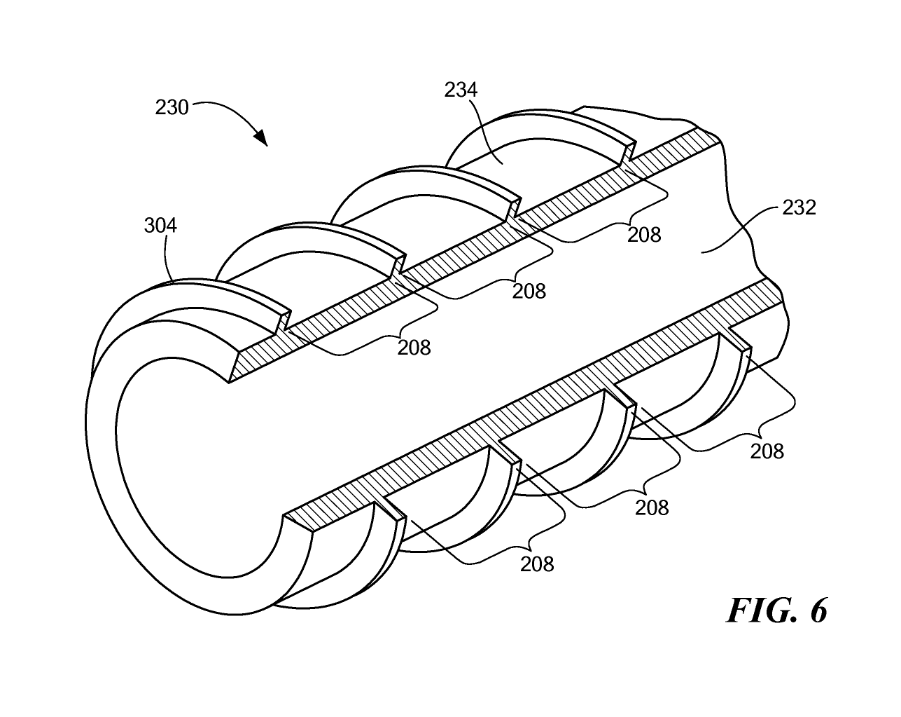

In a fourth embodiment, and with reference now to FIG. 6, the at least one helical wall 300, instead of being provided by a helix member, is provided by a helical rib 304 that is integrally formed with and extends outward from the first outer surface 234 of the inner sleeve 230. The helical rib 304 itself forms a single helical wall between the inner and outer sleeves 230, 280, which in turn forms a single helical fluid flow path 208 between the inner and outer sleeves 230, 280 that extends from the one end 204 to the opposite end 206 of the inner and outer sleeves 230, 280.

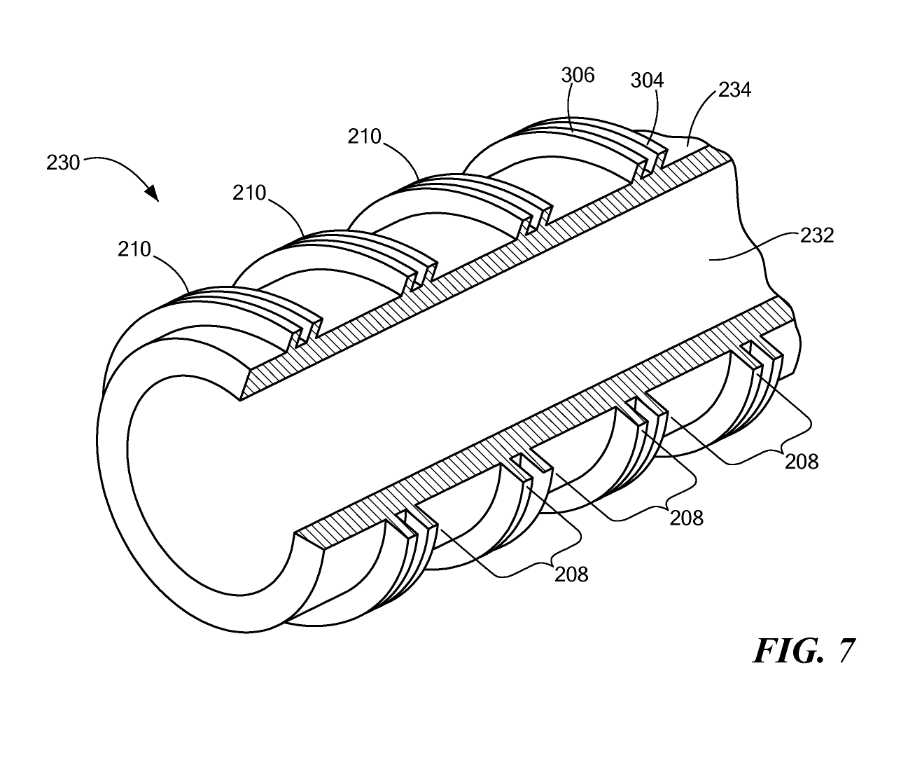

In a fifth embodiment, and with reference to FIG. 7, the at least one helical wall 300 is provided by first and second helical ribs 304, 306 that are integrally formed with and extend outward from the first outer surface 234 of the inner sleeve 230 to form two helical walls between the inner and outer sleeves 230, 280 that extend from the one end 204 to the opposite end 206 of the inner and outer sleeves 230, 280. The second helical rib 306 is disposed in helical equidistance from the first helical rib 304 to provide a space therebetween of uniform cross-section along the helical paths defined by the first and second helical ribs 304, 306. The space outboard of the first and second helical ribs 304, 306 forms a first helical fluid flow path 208, and the space inboard (between) the first and second helical ribs 304, 306 forms a second helical fluid flow path 210. The similarities between the first and second fluid flow paths 208, 210 of FIG. 7 and the first and second fluid flow paths 208, 210 of FIG. 3 will be apparent to one skilled in the art with reference to the figures and description provided herein and without the need for further description.

In an embodiment, the helical rib 304 of FIG. 6, or the first and second helical ribs 304, 306 of FIG. 7 may be integrally formed with the inner sleeve 230 via a twisted extrusion process or extruded casting process, or may be formed via a machining process.

Similar to the third embodiment described above in connection with FIG. 5, a sixth embodiment includes an HHE 200 where the outer sleeve 280 having a single helical groove 288 as depicted in FIG. 5, is assembled to the inner sleeve 230 having a single helical rib 304 as depicted in FIG. 6, with the single helical rib 304 being helically disposed in the single helical groove 288 in a manner previously described herein.

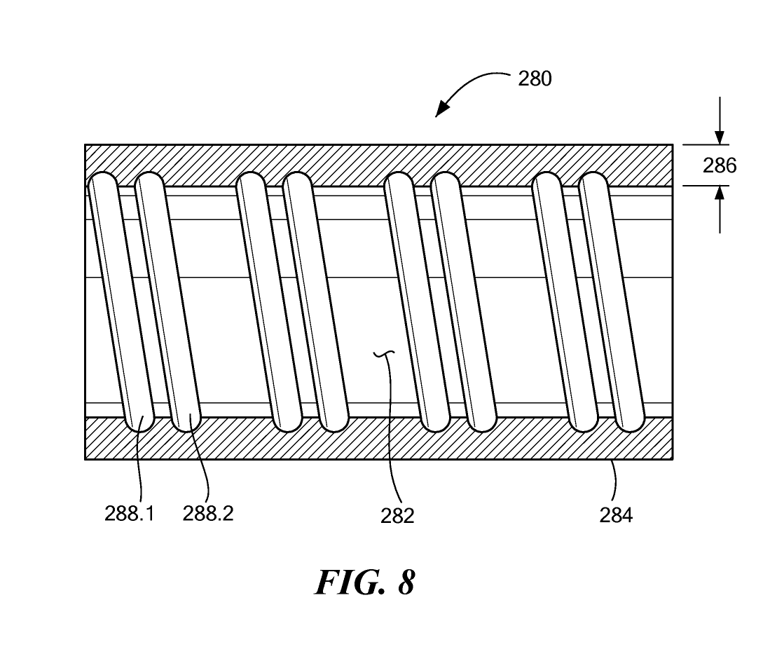

With reference now to FIG. 8, a seventh embodiment includes an outer sleeve 280 having first and second helical grooves 288.1, 288.2 formed in the second inner surface 282 of the outer sleeve 280 partially into the second thickness 286. Similar to the first and second helical ribs 304, 306 depicted in FIG. 7, the second helical groove 288.2 is disposed in helical equidistance from the first helical groove 288.1 at a pitch that mimics the pitch of the first and second helical ribs 304, 306. In this seventh embodiment, the outer sleeve 280 of FIG. 8 is assembled to the inner sleeve 230 of FIG. 7 with the first helical rib 304 disposed in the first helical groove 288.1, and the second helical rib 306 disposed in the second helical groove 288.2.

From the foregoing, it will be appreciated that an embodiment of the invention includes an HHE 200 having any one of the following configurations:

(1) an inner sleeve 230, an outer sleeve 280, and a solid helix member 302a, where the inner and outer sleeves 230, 280 are absent any grooves 238, 288;

(2) an inner sleeve 230, an outer sleeve 280, and a solid helix member 302a, where the inner sleeve 230 includes a groove 238, and the outer sleeve 280 is absent a groove 288;

(3) an inner sleeve 230, an outer sleeve 280, and a solid helix member 302a, where the outer sleeve 280 includes a groove 288, and the inner sleeve 230 is absent a groove 238;

(4) an inner sleeve 230, an outer sleeve 280, and a solid helix member 302a, where the inner sleeve 230 includes a groove 238, and the outer sleeve 280 includes a groove 288;

(5) an inner sleeve 230, an outer sleeve 280, and a hollow helix member 302, where the inner and outer sleeves 230, 280 are absent any grooves 238, 288;

(6) an inner sleeve 230, an outer sleeve 280, and a hollow helix member 302, where the inner sleeve 230 includes a groove 238, and the outer sleeve 280 is absent a groove 288;

(7) an inner sleeve 230, an outer sleeve 280, and a hollow helix member 302, where the outer sleeve 280 includes a groove 288, and the inner sleeve 230 is absent a groove 238;

(8) an inner sleeve 230, an outer sleeve 280, and a hollow helix member 302, where the inner sleeve 230 includes a groove 238, and the outer sleeve 280 includes a groove 288;

(9) an inner sleeve 230, an outer sleeve 280, a single helical rib 304 integrally formed with the inner sleeve 230, and the outer sleeve 280 being absent a groove 288;

(10) an inner sleeve 230, an outer sleeve 280, a single helical rib 304 integrally formed with the inner sleeve 230, and the outer sleeve 280 having a groove 288;

(11) an inner sleeve 230, an outer sleeve 280, two helical ribs 304, 306 integrally formed with the inner sleeve 230, and the outer sleeve 280 being absent a groove 288; and

(12) an inner sleeve 230, an outer sleeve 280, two helical ribs 304, 306 integrally formed with the inner sleeve 230, and the outer sleeve 280 having grooves 288.1, 288,2.

And while not specifically illustrated herein (such illustration being a variant of the multitude of illustrations provided herein), it is also contemplated, and considered to be within the scope of the invention disclosed herein, that an embodiment of the invention includes an HHE 200 having any one of the following configurations:

(13) an inner sleeve 230, an outer sleeve 280, a single helical rib similar to rib 304 but integrally formed with and extending inward toward the central axis of the outer sleeve 280, and the inner sleeve 230 being absent a groove 238;

(14) an inner sleeve 230, an outer sleeve 280, a single helical rib similar to rib 304 but integrally formed with and extending inward toward the central axis of the outer sleeve 280, and the inner sleeve 230 having a groove 238;

(15) an inner sleeve 230, an outer sleeve 280, two helical ribs similar to ribs 304, 306 but integrally formed with and extending inward toward the central axis of the outer sleeve 280, and the inner sleeve 230 being absent a groove 238;

(16) an inner sleeve 230, an outer sleeve 280, two helical ribs similar to ribs 304, 306 but integrally formed with and extending inward toward the central axis of the outer sleeve 280, and the inner sleeve 230 having two of grooves 238;

(17) a unitary integrally formed part having an inner sleeve 230, an outer sleeve 280, and a single helical rib 304, where the unitary integrally formed part is formed via a 3D metal deposition process or printing that progresses in an axial direction while rotating about the central axis; and

(18) a unitary integrally formed part having an inner sleeve 230, an outer sleeve 280, and two helical ribs 304, 306, where the unitary integrally formed part is formed via a 3D metal deposition process or printing that progresses in an axial direction while rotating about the central axis.

Reference is now made to FIG, 9 in combination with FIG. 1, an embodiment includes a single-flow-path arrangement where the electric motor 100 includes a pump 110 and a second heat exchanger 112, which are both operably disposed in fluid flow communication with the helical fluid flow path 208 described above in connection with FIGS. 1-8, where the helical fluid flow path 208 may be provided by any of the aforementioned (18) configurations of an HHE 200 described herein. The pump 110 is disposed and configured to operably drive a first fluid flow medium 114 through the helical fluid flow path 208 to facilitate extraction of heat from at least the stator 104, to deliver heated first fluid flow medium 114 to the second heat exchanger 112 that is disposed and configured to extract heat from the first fluid flow medium 114 to provide cooled first fluid flow medium 114, and to recirculate the cooled first fluid flow medium 114 back through the helical fluid flow path 208 to provide for a continuous heat transfer process. In an embodiment, the first fluid flow medium 114 comprises water, and alternatively comprises an anti-freeze mixture of water and ethylene glycol referred to in the art as WEG.

With reference still to FIG. 9 in combination with FIG. 1, an embodiment includes a double-flow-path arrangement where, in addition to the first helical fluid flow path 208, the HHE 200 also includes a second helical fluid flow path 210, where the second helical fluid flow path 210 may be provided by any of the aforementioned (18) configurations of an HHE 200 described herein that provide for a second helical fluid flow path 210. In the double-flow-path arrangement, a sump 116 is disposed in fluid flow communication with the rotor 104 and the second helical fluid flow path 210, where the rotor 104 is disposed and configured to operably drive, via a vacuum created by rotation of the rotor 104, a second fluid flow medium 118 from the sump 116 through a spacing between the rotor 104 and the stator 102, through the second helical fluid flow path 210 back to the sump 116 to facilitate extraction of heat from the rotor 104 and the spacing between the rotor 104 and the stator 102, to transfer that heat to the WEG in the first helical fluid flow path 208, and to recirculate the second fluid flow medium 118 back through the spacing and the second helical fluid flow path 210 to provide for a continuous heat transfer process. In an embodiment, the second fluid flow medium 118 comprises oil, for example.

While certain types of fluid flow medium are disclosed herein, it will be appreciated that the scope of the invention is not limited to only those particular fluids, and that the cooling system construction disclosed herein can accommodate a variety of liquid cooling types and mediums. Also, while the disclosure herein describes a metal construction for the helical coil cooling system, it will be appreciated that alternate materials such as plastics and composite materials may be used without detracting from the scope of the invention disclosed herein.

From all of the foregoing, it will be appreciated that an embodiment of the invention also includes a method of fabricating a helical heat exchanger for use with an electric motor. In an embodiment, an inner sleeve is formed having a first inner surface and a first outer surface separated by a first thickness. At least one helical wall is provided and disposed on the first outer surface of the inner sleeve extending from one end to an opposite end of the inner sleeve. An outer sleeve is formed having a second inner surface and a second outer surface separated by a second thickness. The outer sleeve is disposed coaxially with and outboard of the inner sleeve with a void between the first outer surface and the second inner surface, with the at least one helical wall disposed between the first outer surface and the second inner surface, and with the at least one helical wall disposed in a fluid-tight arrangement between the first outer surface and the second inner surface. The at least one helical wall is configured and provided to define at least one helical fluid flow path configured to permit at least one heat transfer medium to helically travel within the void between the inner and outer sleeves.

The method further includes metallurgically or chemically bonding the at least one helical wall between the first outer surface and the second inner surface.

The method further includes forming a first helical groove partially into the first thickness of the first outer surface of the inner sleeve, and disposing a helix member in the first helical groove.

The method further includes, wherein the helix member is a solid helix member that defines the at least one helical wall as being a single helical wall, and further defines the at least one helical fluid flow path as being a single helical fluid flow path.

The method further and alternatively includes, wherein the helix member is a hollow helix member that defines the at least one helical wall as being two helical walls, and further defines the at least one helical fluid flow path as being two helical fluid flow paths, a first of the two helical fluid flow paths being within the hollow helix member, and a second of the two helical fluid flow paths being outside the hollow helix member.

The method further includes forming a second helical groove partially in the second thickness of the second inner surface of the outer sleeve, and disposing the helix member in the second helical groove.

The method further includes forming a first helical rib integrally arranged with and extending outward from the first outer surface of the inner sleeve, wherein the first helical rib defines the at least one helical wall as being a single helical wall, and further defines the at least one helical fluid flow path as being a single helical fluid flow path.

The method further includes forming a second helical rib integrally arranged with and extending outward from the first outer surface of the inner sleeve, the second helical rib being disposed in helical equidistance from the first helical rib, wherein the first and second helical ribs define the at least one helical wall as being two helical walls, and further define the at least one helical fluid flow path as being two helical fluid flow paths, a first of the two helical fluid flow paths being outboard of two adjacent ones of the first and second helical ribs, and a second of the two helical fluid flow paths being inboard of the two adjacent ones of the first and second helical ribs.

The method further includes forming a first helical groove partially in the second thickness of the second inner surface of the outer sleeve, and disposing the first helical rib in the first helical groove.

The method further includes forming a second helical groove partially in the second thickness of the second inner surface of the outer sleeve, the second helical groove being disposed in helical equidistance from the first helical groove, and disposing the second helical rib in the second helical groove.

The method further includes using a sealing process, a vibratory welding process, or any type of sealing or welding process suitable for a purpose disclosed herein, to provide the fluid-tight arrangement of the at least one helical wall between the first outer surface and the second inner surface.

The method further includes assembling the outer sleeve to the inner sleeve in a screw-type relation via the helix member.

The method further and alternatively includes assembling the outer sleeve to the inner sleeve in a screw-type relation via the first helical rib.

The method further and alternatively includes assembling the outer sleeve to the inner sleeve in a screw-type relation via the first and second helical ribs.

The method further includes forming the inner sleeve via a twisted extrusion process or extruded casting process.

As described herein, a HHE 200 may be viewed as a coolant waterjacket having; a floor of the waterjacket defined by the area that heat is transferred from the electric motor to the coolant (WEG, for example), such as the inner sleeve 230, for example; walls of the waterjacket defined by the sides or, in most cases, the vertical part of the waterjacket, such as the helix member 302, 302a, or the helical ribs 304, 306, for example; and, a roof or top of the waterjacket defined by the portion farthest away from the hot electric motor, such as the outer sleeve 280, for example. A substantial purpose of the roof and walls of the waterjacket is to contain the coolant, whereas the floor conducts heat from the electric motor to the coolant and provides a robust mounting surface for the electric motor and to carry reaction torque to cooling jacket mounting flanges.

With the advent of new manufacturing processes, it will be appreciated that a helical path may be machined or cast into the floor of the waterjacket, or even 3D printed. The waterjacket floor still forms the mounting and heat path for the stator of the electric motor. Into this helical path, a solid or tubular shape is installed, and “wound” around the helical path. The helical path and solid/tubular shape may start at an end of the inner/outer sleeves or at any place(s) deemed desirable. For example, the helical path may start at one side and end at another side and have any clocking positions for inlets and outlets, or may start at the jacket floor center and wind their way outward, or may have any other start/end configuration as desired for effective cooling of the electric motor. To form the roof of the waterjacket, a sleeve is installed over the helical tubes/shapes. An endcover can be installed on each end of the assembly to form the endwalls of the waterjacket. The assembly can be assembled by a variety of assembly methods, including fasteners, sintering, bonding, friction fit, staking, welding, vibratory welding, cast-in-place, and 3D metal deposition printing, for example.

As coolant enters the helical waterjacket, it moves helically along the passageway created by the helical shaped solid/tubular shapes. Since the passageway is now much smaller than a conventional waterjacket, velocity of the liquid is increased to achieve turbulent or nearly turbulent flow which is most effective in “scrubbing” hot spots from the waterjacket floor. Effectiveness in the “scrubbing” action may be achieved by increasing the surface roughness in the fluid flow paths, or by introducing surface disturbances, such as pins fins in the fluid flow paths, thereby creating more turbulent flow of the fluid flow medium (coolant). Effectiveness of the coolant is also increased in that the length of the coolant passage is much longer than the basic concept and approximately equal to the zig-zag concept noted above.

In an embodiment, a small open section 400 (depicted as a graphic circle for illustration purposes) is provided at the top of the helical shaped solid/tubular shapes or in the second inner surface 282 of the outer sleeve 280 (inner diameter of the waterjacket roof) to allow steam bubbles to escape (best seen with reference to FIGS. 4 and 9 depicting the small open section by a graphic circle). This open section formed between the helix member and the second inner surface of the outer sleeve is large enough to allow steam and entrapped air to escape to the coolant outlet port, but is not large enough to let an appreciable amount of WEG to short circuit the helical fluid flow path. Various methods may be used to form this airflow path. One method may be to form a flat opening on the helical section at or near the 12 o'clock position. Another method may be to provide a channel having a shape of generally semi-circular cross section that is formed into the outer sleeve and installed onto the cooling jacket at or near the 12 o'clock position. As used herein, the term “12 o'clock position” means a position toward the top of the waterjacket when the electric motor is in an installed orientation. Numerous variances to the methods may be employed, with the main purpose being to provide a path to allow entrapped air within the upper portions of the motor to escape quickly.

As described above, when a tubular cross section material is used for the helix member, this tube material may be used to carry coolant for a subsystem in the overall system. In the case of an electric motor, this coolant may be used to cool the subsystem of the inner workings of the motor, such as the conductors, bearings, and rotor. In a typical electric motor, approximately 60-70% of the heat is generated in the stator. The remainder is generated in the rotor and the electric motor internals. If the electric motor is of the enclosed type, which most new generation electric motors are, to avoid liquid ingress and EMI interference, the bearings provide the only method to transfer this heat out of the rotor, since there is no airflow through the electric motor to cool the rotor. Bearings are typically a poor heat conductor, especially since heat generated in the mid-outer periphery of the rotor has a considerable distance to travel to reach the bearings and be conducted out. The coolant used in this sub-system for cooling the internals of the electric motor may be a dielectric oil. Oil from the internal part of the electric motor may be pumped through these tubes, which then transfer heat from the tubes to the WEG coolant. Heat from the tubes can be also conducted to the waterjacket floor and roof. This construction method for a “dual flow cooling medium” cooling system eliminates the need for an extra, external heat exchanger, which often adds significant cost and size to a cooling system.

While embodiments have been described and illustrated herein with helix members and helical features having a generally illustrated pitch, it will be appreciated each mating set of helix member and helical feature may have a uniform pitch or a variable pitch depending on the desired heat transfer characteristics of the HHE 200.

While certain combinations of helix members and helical features have been described herein, it will be appreciated that these certain combinations are for illustration purposes only and that any combination of any of the helix members and helical features may be employed in accordance with an embodiment of the invention. Any and all such combinations are contemplated herein and are considered within the scope of the invention disclosed.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An electric motor, comprising:
a stator;
a rotor disposed axially, magnetically, and operably with respect to the stator; and
a helical heat exchanger disposed outboard of the stator and in thermal communication with at least the stator, the helical heat exchanger comprising:
an inner sleeve having a first inner surface and a first outer surface separated by a first thickness;
an outer sleeve having a second inner surface and a second outer surface separated by a second thickness, the outer sleeve coaxially disposed with and outboard of the inner sleeve with a void therebetween;
at least one helical wall disposed in the void between the inner and outer sleeves extending from one end to an opposite end of the inner and outer sleeves;
the at least one helical wall forming a fluid tight seal along its helical path between the first outer surface and the second inner surface to define at least one helical fluid flow path in the void between the inner and outer sleeves; and
the at least one helical fluid flow path configured to permit at least one heat transfer medium to helically travel within the void between the inner and outer sleeves.

2. The electric motor of claim 1, wherein:
the at least one helical wall extends in a continuous and uninterrupted arrangement from the one end to the opposite end of the inner and outer sleeves.

3. The electric motor of claim 1, wherein:
the first outer surface of the inner sleeve comprises a first helical groove formed partially into the first thickness; and
the at least one helical wall comprises a helix member disposed in the first helical groove.

4. The electric motor of claim 3, wherein:
the helix member is a solid helix member that defines the at least one helical wall as being a single helical wall, and further defines the at least one helical fluid flow path as being a single helical fluid flow path.

5. The electric motor of claim 3, wherein:
the helix member is a hollow helix member that defines the at least one helical wall as being two helical walls, and further defines the at least one helical fluid flow path as being two helical fluid flow paths, a first of the two helical fluid flow paths being within the hollow helix member, and a second of the two helical fluid flow paths being outside the hollow helix member.

6. The electric motor of claim 3, further comprising:
an open section provided at a top of the electric motor between the helix member and the second inner surface of the outer sleeve configured to allow steam and entrapped air to escape to the at least one helical flow path.

7. The electric motor of claim 3, wherein:
the second inner surface of the outer sleeve comprises a second helical groove formed partially in the second thickness; and
the helix member is disposed in the second helical groove.

8. The electric motor of claim 1, wherein:
the at least one helical wall comprises a first helical rib that is integrally formed with and extends outward from the first outer surface of the inner sleeve; and
the first helical rib defines the at least one helical wall as being a single helical wall, and further defines the at least one helical fluid flow path as being a single helical fluid flow path.

9. The electric motor of claim 8, wherein:
the at least one helical wall comprises a second helical rib that is integrally formed with and extends outward from the first outer surface of the inner sleeve;
the second helical rib disposed in helical equidistance from the first helical rib; and
the first and second helical ribs define the at least one helical wall as being two helical walls, and further define the at least one helical fluid flow path as being two helical fluid flow paths, a first of the two helical fluid flow paths being outboard of two adjacent ones of the first and second helical ribs, and a second of the two helical fluid flow paths being inboard of the two adjacent ones of the first and second helical ribs.

10. The electric motor of claim 8, wherein:
the second inner surface of the outer sleeve comprises a first helical groove formed partially in the second thickness; and
the first helical rib is disposed in the first helical groove.

11. The electric motor of claim 9, wherein:
the second inner surface of the outer sleeve comprises a first helical groove and a second helical groove disposed in helical equidistance from the first helical groove, each of the first and second helical grooves formed partially in the second thickness;
the first helical rib is disposed in the first helical groove; and
the second helical rib is disposed in the second helical groove.

12. The electric motor of claim 1, wherein the at least one helical wall is a single helical wall, and the at least one helical fluid flow path is a single helical fluid flow path, and further comprising:
a pump and a second heat exchanger, operably disposed in fluid flow communication with the single helical fluid flow path;
wherein the pump is disposed and configured to operably drive a first of the at least one fluid flow medium through the single helical fluid flow path to facilitate extraction of heat from at least the stator, to deliver heated first fluid flow medium to the second heat exchanger that is disposed and configured to extract heat from the first fluid flow medium to provide cooled first fluid flow medium, and to recirculate the cooled first fluid flow medium back through the single helical fluid flow path to provide for a continuous heat transfer process.

13. The electric motor of claim 1, wherein the at least one helical wall comprises two helical walls, a first helical wall and a second helical wall disposed in helical equidistance from the first helical wall, and the at least one helical fluid flow path comprises a first and a second helical fluid flow path defined by the first and second helical walls, and further comprising:
a pump and a second heat exchanger operably disposed in fluid flow communication with the first helical fluid flow path;
wherein the pump is disposed and configured to operably drive a first of the at least one fluid flow medium through the first helical fluid flow path to facilitate extraction of heat from at least the stator, to deliver heated first fluid flow medium to the second heat exchanger that is configured to extract heat from the first fluid flow medium to provide cooled first fluid flow medium, and to recirculate the cooled first fluid flow medium back through the first helical fluid flow path to provide for a continuous heat transfer process; and further comprising
a sump disposed in fluid flow communication with the rotor and the second helical fluid flow path, wherein the rotor is disposed and configured to operably drive a second of the at least one fluid flow medium from the sump through a spacing between the rotor and the stator, through the second helical fluid flow path back to the sump to facilitate extraction of heat from the rotor and the spacing between the rotor and the stator, and to recirculate the second fluid flow medium back through the spacing and the second helical fluid flow path to provide for a continuous heat transfer process.

14. The electric motor of claim 12, wherein:
the first fluid flow medium comprises water.

15. The electric motor of claim 13, wherein:
the first fluid flow medium comprises water; and
the second fluid flow medium comprises oil.

16. A method of fabricating a helical heat exchanger for use with an electric motor, the method comprising:
forming an inner sleeve having a first inner surface and a first outer surface separated by a first thickness;
providing at least one helical wall disposed on the first outer surface of the inner sleeve extending from one end to an opposite end of the inner sleeve;
forming an outer sleeve having a second inner surface and a second outer surface separated by a second thickness;
disposing the outer sleeve coaxially with and outboard of the inner sleeve with a void between the first outer surface and the second inner surface, with the at least one helical wall disposed between the first outer surface and the second inner surface, and with the at least one helical wall disposed in a fluid-tight arrangement between the first outer surface and the second inner surface;
wherein the at least one helical wall defines at least one helical fluid flow path configured to permit at least one heat transfer medium to helically travel within the void between the inner and outer sleeves.

17. The method of claim 16, further comprising:
metallurgically bonding the at least one helical wall between the first outer surface and the second inner surface.

18. The method of claim 16, further comprising:
forming a first helical groove partially into the first thickness of the first outer surface of the inner sleeve; and
disposing a helix member in the first helical groove.

19. The method of claim 18, wherein:
the helix member is a solid helix member that defines the at least one helical wall as being a single helical wall, and further defines the at least one helical fluid flow path as being a single helical fluid flow path.

20. The electric motor of claim 18, wherein:
the helix member is a hollow helix member that defines the at least one helical wall as being two helical walls, and further defines the at least one helical fluid flow path as being two helical fluid flow paths, a first of the two helical fluid flow paths being within the hollow helix member, and a second of the two helical fluid flow paths being outside the hollow helix member.

21. The electric motor of claim 18, further comprising:
forming a second helical groove partially in the second thickness of the second inner surface of the outer sleeve; and
disposing the helix member in the second helical groove.

22. The method of claim 16, wherein:
the providing at least one helical wall disposed on the first outer surface of the inner sleeve comprises forming a first helical rib integrally arranged with and extending outward from the first outer surface of the inner sleeve; and
the first helical rib defines the at least one helical wall as being a single helical wall, and further defines the at least one helical fluid flow path as being a single helical fluid flow path.

23. The method of claim 22, wherein:
the providing at least one helical wall disposed on the first outer surface of the inner sleeve further comprises forming a second helical rib integrally arranged with and extending outward from the first outer surface of the inner sleeve, the second helical rib being disposed in helical equidistance from the first helical rib; and
the first and second helical ribs define the at least one helical wall as being two helical walls, and further define the at least one helical fluid flow path as being two helical fluid flow paths, a first of the two helical fluid flow paths being outboard of two adjacent ones of the first and second helical ribs, and a second of the two helical fluid flow paths being inboard of the two adjacent ones of the first and second helical ribs.

24. The method of claim 22, further comprising:
forming a first helical groove partially in the second thickness of the second inner surface of the outer sleeve; and
disposing the first helical rib in the first helical groove.

25. The method of claim 23, further comprising:
forming a first helical groove partially in the second thickness of the second inner surface of the outer sleeve, and forming a second helical groove partially in the second thickness of the second inner surface of the outer sleeve, the second helical groove being disposed in helical equidistance from the first helical groove; and
disposing the first helical rib in the first helical groove, and disposing the second helical rib in the second helical groove.

26. The method of claim 16, wherein:
the at least one helical wall disposed in a fluid-tight arrangement between the first outer surface and the second inner surface is fluidly sealed via a sealing process, a welding process, or a vibratory welding process.

27. The method of claim 21, wherein:
the outer sleeve is assembled to the inner sleeve in a screw-type relation via the helix member.

28. The method of claim 24, wherein:
the outer sleeve is assembled to the inner sleeve in a screw-type relation via the first helical rib.

29. The method of claim 25, wherein:
the outer sleeve is assembled to the inner sleeve in a screw-type relation via the first and second helical ribs.

30. The method of claim 22, wherein:
the inner sleeve is formed via a twisted extrusion process or extruded casting process.

31. The method of claim 23, wherein:
the inner sleeve is formed via a twisted extrusion process or extruded casting process.
